(19) United States
(12) Patent Application Publication
(10) Pub. No.: US 2010/0192792 A1
(43) Pub. Date: Aug. 5, 2010

(54) METHOD OF PREDICTING A DRYING PARAMETER FOR A PRINTING PRESS

(76) Inventors: Ronald W. Hall, Corvallis, OR (US); Gary Tarver, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/366,641

(22) Filed: Feb. 5, 2009

(51) Int. Cl. B41F 35/00; F26B 13/10

(52) U.S. Cl. 101/424.1; 34/561

(57) ABSTRACT

A method of predicting at least one drying parameter for a printing press includes estimating an amount and type of an ink to be deposited on a printing surface, determining at least one of: i) a type of the printing surface, ii) a thickness of the printing surface, and iii) a speed of the printing surface moving through the printing press, and calculating, via a controller associated with the dryer, the at least one drying parameter based at least on: i) the amount and the type of the ink to be deposited on the printing surface; ii) the type of the printing surface, iii) the thickness of the printing surface, and iv) the speed of the printing surface moving through the printing press. Also disclosed herein is a method of determining if the ink established on the printing surface is dry.

### BACKGROUND

The instant disclosure relates generally to printing presses.

Printing presses are often used in the commercial production of, for example, newspapers, magazines, books, and the like. Some printing presses, such as, e.g., web presses, use digital printing technology to establish an ink on one or both sides of a continuous sheet of paper, substrate, or other suitable printing surface. Such surfaces are often rolled up or stacked after printing. Printing presses also may have associated therewith a dryer to dry the ink established on the printing surface. In some instances, however, the dryer may not adequately dry the ink established on the printing surface, possibly resulting in damaging the printed ink when the surface is rolled up, stacked, or used after printing. On the other hand, excessive drying of the ink may, in some instances, shrink, discolor, or electrically charge the printing surface, which may deleteriously effect the cosmetic appearance and/or the workability of the printing surface.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals or features having a previously described function may or may not be described in connection with other drawings in which they appear.

FIG. 1A is a schematic diagram showing a printing stage of a printing process using a printing press according to an embodiment of the present disclosure;

FIG. 1B is a schematic diagram showing a drying stage of a printing press using the printing press of FIG. 1A;

FIG. 2 is a flow diagram depicting an embodiment of a method of predicting at least one drying parameter of a printing press;

FIG. 3 is a flow diagram depicting an example of an embodiment of a method of determining if an ink established on a printing surface by embodiment(s) of the printing press is dry;

FIG. 4A is an enlarged, cutaway schematic view of an embodiment of an exhaust system associated with a dryer of a printing press; and

FIG. 4B is an enlarged, cross-sectional semi-schematic view of another embodiment of an exhaust system associated with a dryer of a printing press.

### DETAILED DESCRIPTION

Some embodiment(s) of the methods disclosed herein may advantageously be used to predict at least one drying parameter for a printing press to adequately dry an ink established on a printing surface. The adequate drying parameters may be predicted using a mathematical model operated by a controller associated with the printing press. The controller uses the mathematical model to electronically examine a pending printing job and subsequently supplies, either to an operator of the printing press or to the printing press itself, relevant information based on the examination for predicting the drying parameters. In sharp contrast to existing trial-and-error or other manual methods of predicting adequate drying parameters, the mathematical model automatically predicts the drying parameters based on information or data related to a specific printing job. Embodiment(s) of the method of predicting the drying parameter(s) may, in some instances, save energy, time, and/or costs often associated with other prediction methods, such as the traditional trial-and-error method mentioned above. Embodiment(s) of the method also advantageously reduces potential defects of the printing surface that may occur as a result of under-drying and/or over-drying of the ink.

Other embodiment(s) of the methods disclosed herein may advantageously be used to determine if the ink established on the printing surface is in fact dry. In some instances, such a method may be applied to a printing job where the printing press was operated using the drying parameters determined from the prediction method stated above. In other instances, the method of determining if the ink is dry may be applied to another printing job where the drying parameters were not determined via the prediction method mentioned above. In any event, the method of determining if the ink is dry may be accomplished by measuring at least one element present in an exhaust stream of a dryer associated with the printing press and comparing the measurement to that of the ink established on the paper or comparing the measurement to predetermined values. If, for example, a smaller amount of the element(s) is present in the exhaust stream as compared to i) the ink established on the printing surface prior to drying, ii) the ink established on the printing surface after drying, or iii) predetermined values, then the ink is considered to be dry. Such measurements may be automatically made using a computer readable program operated by the controller of the printing press and the dryness of the ink may be automatically fed back to an operator of the printing press. The operator of the printing press may adjust one or more of the drying parameters if he/she deems necessary. In instances where the printing press is a web press, such adjustments may also be made automatically without any operator intervention and without having to stop a currently-running printing job.

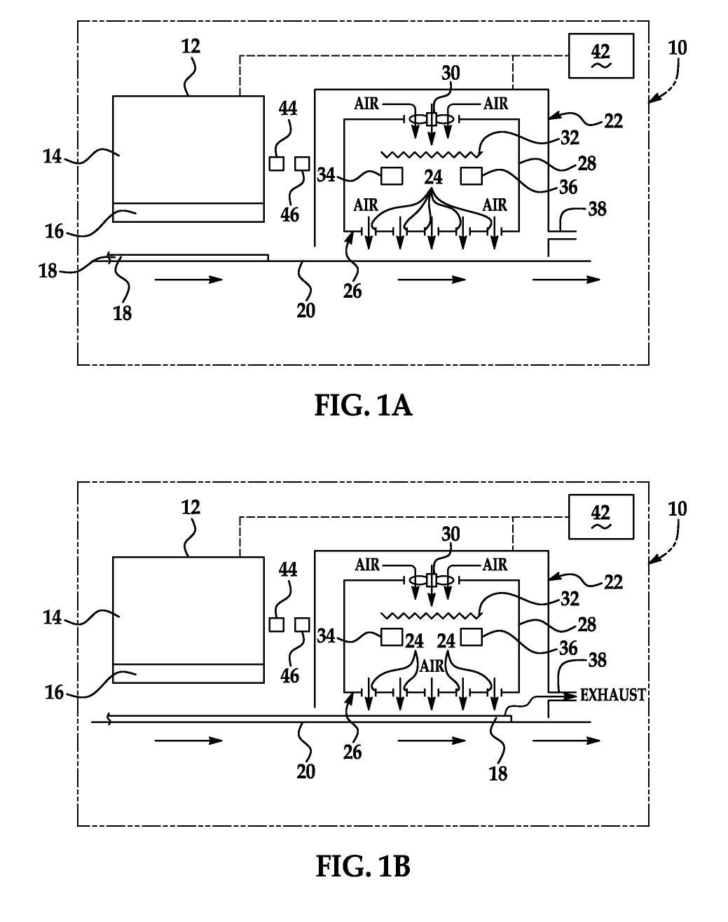

As used herein, the term “printing press” refers to any image forming device that may be used to suitably establish an ink on a printing surface. As described hereinbelow in connection with FIGS. 1A and 1B, the printing press is a digital web press configured to print an image on a substantially continuous sheet of paper, substrate, or other suitable printing surface, often rolled up before and/or after printing. It is to be understood that embodiment(s) of either of the methods described herein may also be applied to other printers, examples of which include non-web press digital printers, inkjet printers, inkjet copiers, and/or the like.

Referring now to the figures, a schematic representation of a printing press 10 is shown in FIGS. 1A and 1B, where FIG. 1A depicts a printing stage of a particular printing job using the printing press 10 and FIG. 1B depicts a drying stage of the particular printing job. The printing press 10 generally includes a printer portion 12 including an ink reservoir 14 for storing an ink therein and a printhead 16 for ejecting the ink retrieved from the ink reservoir 14 onto a printing surface 18 during the printing stage (shown in FIG. 1A). The printer portion 12 is schematically shown in FIGS. 1A and 1B as an ink cartridge including the ink reservoir 14 and the printhead 16. It is to be understood, however, that the printer portion also includes other components of a printer, but are not shown in the schematic drawings of FIGS. 1A and 1B to simplify the drawings.

During the printing stage, the printer portion 12 establishes or deposits the ink on the printing surface 18 by ejecting the ink from the printhead 16 (as stated above). The printing surface 18 may, for example, be any suitable surface configured to receive and absorb the ink established thereon, non-limiting examples of which include various forms of media such as plain paper, coated paper, and/or the like, and/or combinations thereof. The printing surface 18 may also be any suitable surface configured to just receive the ink established thereon, an example of which includes transparencies. Such printing surfaces 18 are often provided before printing as a continuous rolled up sheet and/or a continuous sheet capable of being rolled up after printing. For non-web press printers, the printing surface 18 may be provided in individual, separate sheets and may be retrieved from one or more media trays often associated with such printers.

The printing press 10 further includes a print surface carrier 20 configured carry a portion of the printing surface 18 from an area of the press 10 where the printing stage occurs to an area of the press 10 where the drying stage occurs (shown in FIG. 1B). In the example shown in FIGS. 1A and 1B, the carrier 20 is a conveyer belt disposed below the printhead 16 and a dryer 22 (which will be described in further detail below). Another example of the carrier 20 includes a plurality of rollers configured to carry the printing surface 18 from, e.g., the printing area to the drying area. During the printing stage of the printing process, the carrier 20 positions the portion of the printing surface 18 stretched out from the roll underneath the printhead 16, allowing the printhead 16 to eject the ink onto the surface 18 (as shown in FIG. 1A). Then, during the drying stage of the printing process, the carrier 20 positions the same portion of the printing surface 18 underneath the dryer 22, allowing the dryer 22 to dry the ink ejected onto the surface 18 (as shown in FIG. 1B).

The dryer 22 associated with the printing press 10 may be located within the printing press 10 (as shown in FIGS. 1A and 1B), or may be located outside of the printing press 10 (not shown). In either configuration, the dryer 22 applies hot air to the ink deposited onto the portion of the printing surface 18 when the carrier 20 positions that portion of the surface 18 underneath the dryer 22. It is to be understood that in instances where the printing surface 18 is a continuous sheet, the printing stage (as shown in FIG. 1A) and the drying stage (as shown in FIG. 1B) of the printing process will occur substantially simultaneously for different portions of the continuous sheet as the sheet (i.e., the surface 18) is carried by the carrier 20. It is further to be understood that the printing stage and drying stages may otherwise occur sequentially such as, e.g., when the surface 18 is an individual sheet, such as those used in various inkjet printers, copiers, or the like.

The dryer 22 is also schematically shown in FIGS. 1A and 1B. The dryer 22 may be any suitable ink-drying device operatively included in, connected to, or otherwise associated with the printing press 10. Non-limiting examples of suitable dryers include hot air dryers, infrared dryers, radio frequency dryers, microwave dryers, radiant heat dryers, and/or the like.

In an embodiment, the dryer 22 includes at least one nozzle 24 (a plurality of which are shown in FIGS. 1A and 1B) formed in a surface 26 of a housing 28 opposed to the carrier 20. The dryer 22 further includes a blower 30 configured to direct air through the housing 28. The air that is directed through the housing 28 by the blower 30 is heated via a heating element 32 near the blower 30. As shown in FIG. 1B, the heated air passes through the nozzle(s) 24 and contacts the underlying printing surface 18 to dry the ink established thereon. Any effluent generated during the drying process exits the dryer 22 through an exhaust stream 38 in fluid communication with the dryer 22.

In an example, the dryer 22 further includes a temperature sensor 34 and a humidity sensor 36 disposed inside the housing 28. The temperature 34 and humidity 36 sensors may be used to determine the temperature of the air flowing through the dryer 22 and the humidity level inside the dryer 22, respectively.

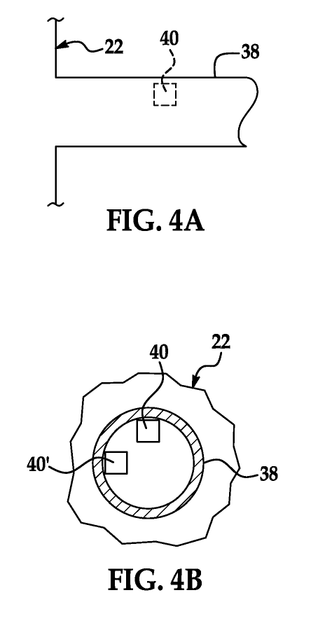

In another example, the exhaust stream 38 also includes at least one sensor 40 operatively connected thereto (shown in FIG. 4A). The sensor 40 may, in an embodiment, be a flow sensor configured to measure the flow rate of at least one element present in the exhaust effluent generated during the drying stage of the printing process. Non-limiting examples of the element include a volatile organic compound (VOC), aldehydes, water, or combinations thereof. In another embodiment, the sensor 40 may be configured to identify the element(s) present in the exhaust effluent. In yet another embodiment, the sensor 40 may be configured to measure an amount of the element(s) present in the exhaust effluent. In still another embodiment, the sensor 40 may represent one or a number of different sensors capable of measuring one or more of the following: the velocity of the air traveling through the exhaust stream 38, the flow rate of the air traveling through the exhaust stream 38, the temperature of the exhaust effluent, the moisture content of the exhaust effluent, the amount of VOC's present in the exhaust stream 38, the identity of the VOC's, the amount and type of any aldehydes present in the exhaust effluent, and/or the like. For example, a hot wire anemometer may be used to measure the flow rate, temperature, and/or the moisture content of the exhaust effluent, a hydrocarbon analyzer (e.g., a TECO Model 51) may be used to measure VOC's present in the exhaust effluent, dinitro-phenyl hydrazine (DNPH) air sampling cartridges may be used to measure aldehydes in the exhaust effluent, and/or Tenax® tubes may be used to analyze components of the VOC's in the exhaust stream.

Other sensors may also be used in the printing press 10 and associated with the dryer 22, the printing surface 18, or other suitable components of the press 10 to measure, for example, a thickness of the printing surface 18, a temperature of the printing surface 18, a moisture level of the printing surface 18, and/or combinations thereof. Sensors for measuring the moisture content and/or the temperature of the printing surface 18 may be used upstream and/or downstream of the carrier 20. For example, as shown in FIGS. 1A and 1B, a temperature sensor 44 (e.g., an infrared temperature sensor) may be used to measure the temperature of the printing surface 18, and moisture sensor 46 (e.g., an infrared moisture meter) may be used to measure the moisture content of the printing surface 18. The sensors 44, 46 may both be placed upstream of the dryer 22 (as shown in FIGS. 1A and 1B), downstream of the dryer 22, or both.

The printing press 10 further includes a controller 42 in operative communication with any of the sensors used in the printing press 10 (e.g., the sensor 34, 36, 40, 44, 46, etc.), the dryer 22, the heating element 32, the blower 30, an exhaust damper (not shown) located within the exhaust stream 38, and the printer portion 12. The controller 42 is shown in the drawings as being located within the printing press 10. It is to be understood, however, that the controller 42 may otherwise be located outside of the printing press but in communication therewith via a wired or a wireless connection.

The controller 42 generally includes i) a processor for computing and/or running one or more computer readable programs or mathematical models, and ii) a memory for storing the computer readable programs and/or mathematical models. In some instances, the memory may also be configured to store a performance and/or operation history of the printing press 10 for use in one or more of the programs or models. As will be described in further detail below, the controller 42 specifically includes at least i) a computer readable program for predicting at least one drying parameter for the printing press 10 and ii) a computer readable program for determining a level of dryness of the ink established on the printing surface 18.

The controller 42 further includes an ink usage estimator configured to estimate an amount (in terms of volume) of the ink to be deposited on the printing surface 18 during a particular printing job. For example, the ink usage estimator estimates the number of ink drops ejected from the printhead 16. The number of electrical pulses to the printhead 16, as well as the electrical resistance and bore diameter of each nozzle 24, and the temperature of the printhead 16 may be used to estimate and determine the volume of the ink actually deposited on the printing surface 18.

In an embodiment, the printing press 10 further includes means for inputting information into the printing press 10 that may be used by the controller 42 for predicting the drying parameter(s) and/or determining the level of dryness of the ink. In an example, the inputting means may be a machine readable scanner (e.g., a barcode scanner or the like) configured to scan and read barcode labels including information related to the ink and/or the printing surface 18. In some instances, the barcode labels may be included on a packaging of the ink by the manufacturer. In these instances, the barcode label may include, for example, the name of the manufacturer, the manufacturing date, the lot number, the type of ink, the color of the ink, and/or the like. From the foregoing information, a composition of the ink may be deduced by, e.g., comparing the information to composition information provided in a look-up table. In other instances, the barcode labels may be generated by an operator of the printing press 10, where such barcode labels include the composition of the ink (including the amounts of each element in the ink (e.g., in volumetric percents)) used by the printing press 10. Such information may be known by the operator of the printing press 10 using a known ink. If an unknown ink is used, the information may i) be experimentally determined, or ii) be deduced from comparing the color of the unknown ink to predetermined composition values provided in a look-up table. In another example, the inputting means may be a keypad operatively associated with the controller 42 for manually inputting (e.g., via typing) the composition of the ink into the controller 42.

In an example, the printing press 10 also includes a manual control element (not shown) operatively associated with the controller 42 and configured for manual adjustment of one or more drying parameters. The manual control element may also be operatively connected to a user interface having a display (also not shown). The display may be used to allow an operator of the printing press 10 to manually adjust one or more of the drying parameters and/or to obtain information related to a dryness level of the ink established on the surface 10 during the printing process.

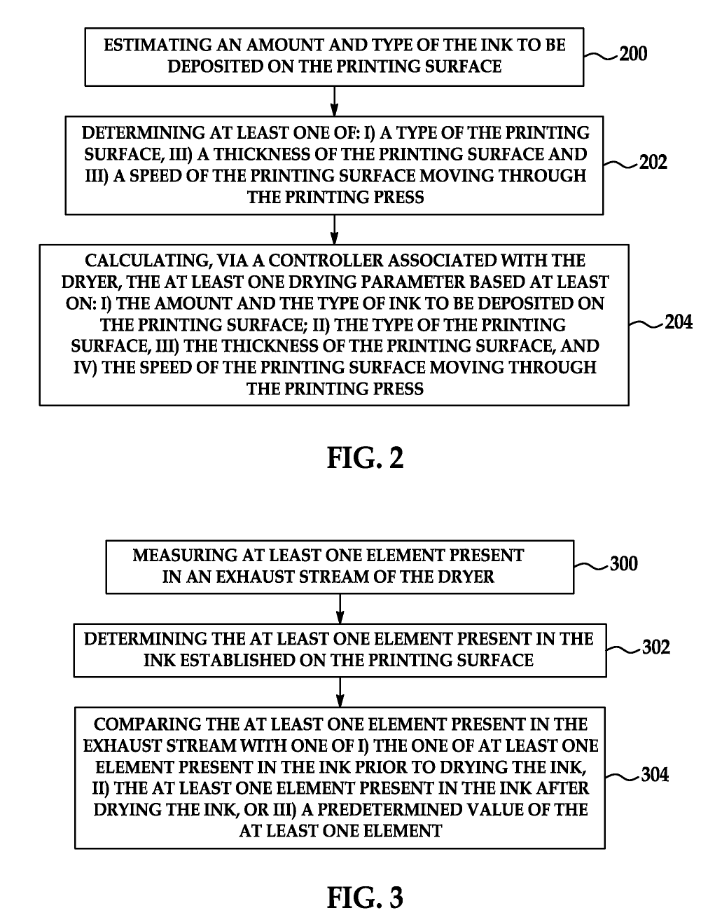

A flow diagram of an example of the method of predicting at least one drying parameter for the printing press 10 is shown in FIG. 2. As used herein, a “drying parameter” refers to a setting of the printing press 10 that enables the dryer 22 to adequately dry the ink established on the printing surface 18 during the drying stage of the printing process. As also used herein, the phrase “adequate drying” of the ink refers to substantially completely drying the ink without excessive drying or over-drying.

The example of the method depicted in FIG. 2 includes estimating an amount and type of ink to be deposited on the printing surface 18 (as shown by reference numeral 200). In an embodiment, the amount and type of ink to be deposited on the printing surface 18 are estimated at least from an amount and type of ink delivered from the printhead 16 during the printing stage of the printing process shown in FIG. 1A. In a non-limiting example, the amount and type of ink delivered from the printhead 16 and deposited onto the printing surface 18 estimated from the number of ink drops, a resistance and bore diameter of each nozzle 24, and a temperature of the printhead 16. For example, the number of ink drops may be determined using the ink usage estimator. The resistance and the bore diameter of each nozzle 24 may be pre-recorded on a computer chip operatively associated with the printhead 16. Additionally, the temperature of the printhead 16 may be measured using a temperature sensor operatively associated with the printhead 16. A processor in operative communication with the computer chip and ink usage estimator utilizes at least these variables to estimate the amount of ink to be deposited on the printing surface 18. It is to be understood that the estimated amount and type of the ink may be used to determine the drying parameters for a then-current printing job and/or a future printing job.

The example of the method shown in FIG. 2 further includes determining at least one of i) a type of the printing surface 18, ii) a thickness of the printing surface 18, and iii) a speed of the printing surface 18 moving through the printing press 10 (as shown by reference numeral 202).

The type of printing surface 18 may be classified according to a brand name (such as, e.g., book paper, bond paper, newsprint paper, etc.), a surface finish (such as, e.g., gloss, matt, etc.), a weight of the printing surface 18 (e.g., 40 lb paper, 80 gsm paper, etc.), a chemical makeup of the surface 18 (e.g., cellulose paper, thermoplastic films, etc.), or the like. In an example, the type of the printing surface 18 may be known and inputted into the controller 42.

Inputting may be accomplished, for example, by typing a specific code into the keypad, where the code identifies the type of surface 18. Inputting may otherwise be accomplished by selecting the type of surface 18 from a menu of previously stored options, where the menu is presented to the user on the display associated with the printing press 10. Inputting may also otherwise be accomplished by scanning a barcode label associated with, e.g., a packaging of the printing surface 18 using the barcode scanner operatively associated with the printing press 10. For example, the barcode scanner scans the barcode label before the printing surface 18 is installed into the printing press 10 and automatically inputs, into the controller 42, the type of printing surface 18.

The controller 42 uses the type of printing surface either read from the barcode label or manually inputted via the keypad to determine additional information characteristic of the printing surface 18. Such additional information includes, for example, a width, a thickness, a length, a weight, a surface finish, and/or a composition of the printing surface 18. In an example, such information may be retrieved from a look-up table of predetermined values for the type of printing surface, which may automatically be inputted into the computer program operated by the controller 42. In another example, the information may be retrieved from the look-up table and may be outputted to the operator of the press 10 on the display. The operator may then, at his/her discretion, manually select to use some or all of the retrieved information in the computer program.

The speed of the printing surface 18 moving through the printing press 10 may, for example, be determined using a speed sensor (not shown in FIGS. 1A and 1B) operatively associated with the carrier 20 upstream and/or downstream of the dryer 22. The speed may be outputted to the operator of the printing press 10 or automatically sent to the controller 42.

The computer program operated by the controller 42 calculates at least one drying parameter of the printing press 10. As will be described below, the calculation is based, at least in part, on the estimated amount and type of the ink, some or all of the characteristic information of the printing surface 18 (e.g., the type of printing surface, etc.), and the speed of the printing surface 18 moving through the printing press 10 (as shown by reference numeral 204). Non-limiting examples of drying parameters include a dryer 22 air temperature, a dryer 22 air velocity, a dryer 22 air flow rate applied to the ink by the blower 30 for drying the ink (referred to herein as the air flow), a humidity level inside the dryer 22, a printing surface 18 dwell time inside the dryer 22, or combinations thereof. In instances where the dryer 22 is an infrared dryer, the drying parameters may further include an energy level of the dryer 22. Furthermore, in instances where the dryer 22 is a radio frequency dryer or a microwave dryer, the drying parameters may further include an energy level of the dryer 22 and a frequency level of the dryer 22. It is to be understood that the drying parameters are threshold values of, for example, the dryer temperature, air flow, and/or humidity level of the dryer 22 that will sufficiently dry the ink deposited on the printing surface 18. It is further to be understood that these threshold values enable drying of the ink without excessive drying or over-drying (as mentioned above). Excessive or over-drying may, in some instances, waste energy, destroy the printing surface 18, destroy the ink established on the printing surface 18, shrink the printing surface 18, discolor the ink established on the printing surface 18, discolor the printing surface 18 itself, and/or the like, and/or combinations thereof.

In an embodiment, the computer program run by the controller 42 calculates the drying parameter(s) by determining i) an estimated ink coverage amount, ii) an estimated highest ink coverage amount, and iii) an expected variation of the ink coverage amount. Such determination may be made based, at least in part, on the amount and type of ink to be deposited on the printing surface 18, the type of the printing surface 18, the thickness of the printing surface 18, the temperature of the printing surface 18, the moisture content of the printing surface 18, and the speed of the printing surface 18 moving through the printing press 10. In an embodiment, after the estimated ink coverage amount, the estimated highest ink coverage amount, and the expected variation of the ink coverage amount are determined, the amounts are compared to predetermined values (e.g., experimentally determined values) present in a look-up table previously stored in the memory associated with the controller 42. The predetermined values have associated therewith suitable drying parameters or settings that are outputted to the operator or automatically applied to the printing press 10.

In another embodiment, after the estimated ink coverage amount, the estimated highest ink coverage amount, and the expected variation of the ink coverage amount are determined, the amounts are inputted into a mathematical model, operated by the controller 42, to determine the drying parameters sufficient to dry the ink to be deposited on the printing surface. The mathematical model may, for example, be formulated to determine drying parameters (based, at least in part, on the estimated ink coverage amount, the estimated highest ink coverage amount, and the expected variation of the ink coverage amount) for a variety of printing applications. Examples of such printing applications include, but are not limited to books, newspapers, direct mail, transactional mail, packaging materials, various types and thicknesses of media, and/or the like, and/or combinations thereof.

As referenced above, a history of the performance or the operating conditions of the printing press 10 are stored in the memory associated with the controller 42. The performance or operation history may include, for example, drying results from one or more previously-run drying processes and the drying parameters used to achieve those drying results. The drying parameter(s) of the previously-run drying process(es) may be used in combination with i) the amount and type of ink deposited or established on the printing surface 18, ii) the type of the printing surface 18, iii) the thickness of the printing surface 18, and iv) the speed of the printing surface 18 moving through the printing press 10 to determine the drying parameter(s) for a then-current printing job. The performance history of the printing press 10 may be used, for example, as a benchmark for subsequent drying of an ink established on substantially the same printing surface. In some instances, the performance history may also be used, for example, to predict drying parameters for drying an ink deposited on a new printing surface. In such instances, the predicted drying parameters may be based on estimates determined from the known printing surfaces included in the performance history.

In yet another embodiment, after drying the ink deposited on the printing surface 18 via the dryer 22, an example of the method further includes confirming that the drying parameter(s) applied to the then-current printing job dried the ink adequately and non-excessively. Confirming the adequacy and the non-excessivity of the drying of the ink may be accomplished by measuring i) a temperature of the printing surface 18 while the printing surface 18 is still in the printing press 10, ii) a moisture content of the printing surface 18 having the ink established thereon while the printing surface 18 is still in the printing press 10, iii) a flow rate of the element(s) present in the exhaust stream 38, iv) roller tracking of the printing press 10, v) blocking of the printing press 10, vi) smearing of the printing press 10, vii) web tracking of the printing press 10, or viii) combinations thereof.

Measuring the temperature and/or the moisture content of the printing surface 18 may be accomplished by sensing the temperature and/or the humidity level of the surface 18 using, for example, the sensors 44, 46. In an example, it is generally known that if the temperature of a printing surface increases up to a predetermined point, then any volatile components once present on the printing surface have been evaporated. It is also known that if volatile components are still present on the printing surface, then the temperature typically stays near a lower temperature while the volatile components are evaporating. Once evaporation is complete, the temperature rises. Accordingly, if, for example, the temperature of the printing surface 18 is a temperature at or above the predetermined point, one may conclude that the volatile components have evaporated and that the printing surface 18 is in fact dry. On the other hand, if the temperature is lower than the predetermined point, then one may conclude that the volatile components are still present on the surface 18 and that further drying is needed.

Additionally, the flow rate of the elements in the exhaust stream 38 may be measured using a flow rate sensor (represented, for example, by the sensor 40 in FIGS. 1A and 1B) operatively connected to the exhaust stream 18. The flow rate of the elements in the exhaust stream 38 may be compared to a flow rate of the elements in the ink entering the dryer 22. The flow rate of the elements in the ink entering the dryer 22 may be measured using a flow rate sensor (not shown in FIGS. 1A and 1B) operatively associated with the printing surface 18 located upstream of the dryer 22. If, for example, the difference between the two flow rates exceeds a predetermined threshold, then the printing surface 18 is considered to be dry.

Furthermore, roller tracking, blocking, smearing, and/or web tracking of the printing press 10 may be used to determine the dryness of the ink as follows. Roller tracking generally refers to wet ink that is transferred from the printing surface 18 to the rollers downstream of the dryer 22. Accordingly, if roller tracking is evident, then the ink is not dry. Blocking refers to transferring ink from different sheets or layers of the printing surface 18 to another sheet or layer. For example, if the printing surface 18 is rolled up after drying, overlapping portions of the printing surface 18 stick together. If blocking occurs when the printing surface 18 is rolled up (or stacking if the printing surface 18 is an individual sheet), then the ink established on the printing surface 18 is not dry. Smearing refers to when the ink established on the printing surface 18 smears when touched. If, for example, the ink does in fact smear after drying, then the ink established on the printing surface 18 is not considered to be dry. Web tracking refers to when the ink is deposited on an original deposition location of the printing surface 18, transfers to a roller of the printing press (because the ink is still wet), and then transfers back to the printing surface 18 in another location. In an example, web tracking occurs when ink transferred to a roller of the printing press 10 transfers back onto the printing surface 18 at a different location (e.g., one diameter distance away from an appropriate position). If web tracking occurs after drying of the ink, then the ink is also considered not to be dry.

It is to be understood that the drying parameters determined using the examples of the prediction method described above may be used, by an operator of the printing press 10, to adjust the settings of the printing press 10 (e.g., the dryer 22). In some instances, the settings may be manually adjusted by the operator using the user interface associated with the printing press 10, leaving the adjustment to the discretion of the operator. In other instances, the settings may automatically be adjusted, upon command from the controller 42, with very little (if any) intervention by the operator.

A flow diagram of an example of the method of determining if the ink established on the printing surface 18 is dry is shown in FIG. 3. The method includes measuring at least one element present in the exhaust stream 38 of the dryer 22 (as shown by reference numeral 300), determining the element(s) present in the ink established on the printing surface 18 (as shown by reference numeral 302), and comparing the element(s) present in the exhaust stream 38 with i) the element(s) present in the ink prior to drying the ink, ii) the element(s) present in the ink after drying the ink, or iii) predetermined values of the element(s) (as shown by reference numeral 304). It is to be understood that an “element,” as used herein, refers to a component present in the exhaust stream 38 and/or in the ink established on the surface 18. Non-limiting examples of the element include volatile organic compounds (such as, e.g., carbon-based solvents including ketones, etc.), aldehydes, water, or combinations thereof.

In an example of the method of determining the dryness of the ink, an amount and an identity of, e.g., a volatile organic compound (VOC) in the exhaust stream is measured and compared to the VOC in the ink prior to drying the ink. In another example of the method, an amount and an identity of a VOC (if any) in the exhaust stream 38 are measured and compared to the VOC (if any) in the ink after drying the ink. In either case, one way of measuring the amount and identity of the VOC in the exhaust effluent is to measure the volumetric flow rate of the VOC.

Measuring the flow rate may be accomplished using a single sensor 40 (such as, e.g., a TECO Model 51 total hydrocarbon analyzer) operatively connected to the exhaust stream 38. In another example, as shown in FIG. 4B, the VOC is measured using the flow rate sensor 40 and another flow rate sensor 40′ disposed in the exhaust stream 38 and angularly offset about ninety degrees from the sensor 40. Without being bound to any theory, it is believed that the 90 degree offset of the sensors 40, 40′ enables substantially accurate sensing of the flow rate of the VOC moving through the exhaust stream 38. It is to be understood that the sensors 40, 40′ in this example is desirably located inside the exhaust stream at positions distant from, e.g., any gates, valves, or bends in any ductwork used for the exhaust stream 38 so that the sensors 40, 40′ can measure the flow rate of the VOC when the flow of the exhaust effluent is laminar.

In an example, the printing surface 18 having the ink established thereon enters the dryer 22 at a particular rate (e.g., measured in ft/min). The rate of the printing surface 18 entering the dryer 22 may be considered as a flow rate of wet material coming into the dryer 22. The exhaust stream 38 evaporates at least some of elements (e.g., VOC's, water, etc.) of the ink established on the printing surface 18 also at a particular rate. The rate of evaporation in the exhaust stream 38 may be considered a flow rate of wet material leaving the dryer 22. The difference between the flow rate of wet material coming into the dryer 22 and the flow rate of wet material leaving the dryer 22 generally provides a level of dryness of the ink established on the printing surface 18 after drying (i.e., leaving the dryer 22).

In yet another example, rather than measuring the flow rate of the elements present in the exhaust stream 38, the amount and identity of the elements (e.g., a VOC) may be determined by collecting the exhaust effluent in, e.g., adsorption tubes. For example, an air sample taken from the exhaust stream 38 may be pulled through Tenax® tubes and analyzed for the identity and amount of VOC's. Analyzing may be accomplished via gas chromatography or mass spectroscopy to determine the amount and identity of the VOC's present in the exhaust effluent. Analyzing may also be accomplished using a dinitro-phenyl hydrazine (DNPH) air sampling technique for detecting aldehyde vapors for determining the amount and identity of any aldehydes in the exhaust stream 38, or via a photo-initiation detector (PID) to detect fugitive emissions. In some instances, the measurement for the elements in the exhaust stream 38 may be sent to a hydrocarbon analyzer to determine the amount and identity of any VOC's in the exhaust stream 38.

The identity and amount of elements in the exhaust stream 38 determined by any of the methods above may be automatically sent to the controller 42 for use in determining the dryness of the ink. The information may also be used, by the controller 42, to adjust one or more dryer 22 settings to achieve adequate drying of a particular printing job.

The composition of the ink used to form the printed image on the printing surface 18 is often known. In these instances, the composition of the ink may, for example, be inputted into the controller 42 by the operator of the printing press 10. In another example, the composition of the ink may be included in a barcode label associated with the ink and the barcode label may be scanned into the controller 24 using the barcode scanner. In yet another example, the composition of the ink may be calculated or otherwise determined using the ink usage estimator described above. The controller 42 uses the composition of the ink to determine the type of VOC's present in the ink. Furthermore, the composition information may be used to determine the boiling point and evaporation rates of the ink, as well as the amount of each component of the composition established on the printing surface 18.

In some instances, however, the composition of the ink is not known. In such instances, the amount and identity of the elements present in the ink are measured. Measuring the amount and identity of the elements present in the ink may be accomplished using a hydrocarbon analyzer or a mass spectrometer. Such information may then be sent to the controller 42 for use in determining the dryness of the ink.

The measurements of the elements in the exhaust stream 38 and in the ink are then used in a computer program run by the controller 42 to determine if the ink established on the printing surface 18 is dry. In an example, the rate of VOC's coming out of the printing surface 18 may be used to determine if the ink is dry. For example, since VOC's tend to absorb into the printing surface 18 when the ink is established thereon, one may deduce the rate of the VOC's coming out of the printing surface 18 if the amount of VOC's present in the exhaust stream is known.

In another example, the determination of whether the ink established on the printing surface 18 is dry may be accomplished by comparing the VOC measurements taken from the exhaust stream 38 with predetermined values (presented, e.g., in a look-up table) previously stored in the memory associated with the controller 42. These predetermined values may be experimentally determined and downloaded into the controller 42 prior to drying.

In another example of the method of determining the dryness of the ink, a moisture content/water in the exhaust effluent and a moisture content/water in the printing surface 18 including the ink established thereon prior to drying are both measured and compared to a moisture content of the printing surface 18 with the ink established thereon after drying. For example, the moisture content of the exhaust stream may be measured using a moisture sensor operatively connected to the exhaust stream 38. The moisture content of the ink may also be measured by measuring the moisture content of the printing surface 18 including the ink via a moisture sensor operatively associated with the printing surface 18. In an example, a sensor may be used prior to the printing surface 18 entering the dryer 22 (such as, e.g., the sensor 46) to measure the moisture content of the printing surface 18 prior to drying and another sensor (not shown in FIGS. 1A and 1B) may be used after leaving the dryer 22 to measure the moisture content of the printing surface 18 after drying. Such measurements are sent to the controller 42 to determine if the ink established on the printing surface 18 (after drying) contains high amounts of water as compared to the exhaust effluent and the printing surface 18 prior to drying. If, for example, the moisture content of the printing surface 18 after drying is below a predetermined value, then the ink is considered to be sufficiently dry.

In yet another example, the dryness of the ink established on the printing surface 18 may be determined by measuring a temperature of the exhaust effluent and a temperature of the printing surface 18 including the ink established thereon prior to drying. The measurements are compared to a temperature of the printing surface 18 with the ink established thereon after drying. If, for example, the temperature of the printing surface 18 is above a predetermined value, then the ink is considered to be sufficiently dry.

It is to be understood that the examples of the method of determining the dryness of the ink may be used alone or may be used in combination. For example, more than one element may be measured and compared with that of the ink to determine dryness. The more than one element may be i) all VOC's, ii) one or more VOC's and water, iii) one or more VOC's, one or more aldehydes, and water, iv) one or more aldehydes and water, v) all aldehydes, or iii) others.

If the controller 42, via the computer program using the data described above, determines that the ink established on the printing surface 18 is in fact dry, then the surface 18 including the dried ink may be removed from the printing press 10 and used, laminated, cut, rolled up, or the like without damaging the printed image on the surface 18. If, on the other hand, the controller 42 determines that the ink is not dry, the controller 42 may run another computer readable program to determine the level of dryness for drying the ink (also referred to herein as a needed dryness). As used herein, a “level of dryness” or “needed dryness” refers to a drying parameter that that is determined based on at least one printing degradation factor, examples of which include i) roller tracking, ii) blocking, iii) smearing, and iv) web tracking. The presence of the element(s) in the exhaust stream 38 is then correlated to each of the foregoing factors to determine the level of dryness. If dryness has not been achieved, one or more drying parameters or settings may be changed by the controller 42. In an example, the changing of the drying parameters may occur automatically so that the new drying parameters are used during a currently pending printing job.

In an embodiment, the correlation between the element(s) in the exhaust stream 38 and the level of dryness may be used to enable automatic feedback of the level of dryness to the controller 42. The controller 42 uses the level of dryness to automatically adjust at least one of i) a parameter of the dryer 22, or ii) a parameter of the printing press 10 to achieve a target dryness level of the ink established on the printing surface 18. In an example, the target dryness level may be determined, for example, from prior experiments and a table of target dryness levels may be downloaded to the controller 42. The target dryness level for a current printing job may be determined from comparing sensor outputs in the exhaust stream 38 with the target dryness values provided in the table. The controller 42 may, for example, automatically adjust, on the printing press 10, a type of printing surface 18, a thickness of the printing surface 18, a speed of the printing surface 18, an amount of ink established on the printing surface 18, a composition of the ink, an amount of bonding agent used in combination with the ink, and/or the like, and/or combinations thereof. In another example, the controller 42 automatically adjusts, on the dryer 22, an air temperature of the dryer 22, an air velocity impinging on the printing surface 18, a humidity level of the dryer 22, an exposure time of the printing surface to the air in the dryer 22, a moisture content of make up air (i.e., air that is drawn in from outside of the dryer 22 to replace air that is leaving the printing press 10 through the exhaust stream 28), temperature of make up air, and/or the like, and/or combinations thereof.

In another example, if the controller 42 determines that the ink established on the printing surface 18 is not dry, the controller 42 may automatically adjust the air temperature of the dryer 22 and/or increase air velocity of the dryer, etc. to achieve the desired dryness of the ink. After the adjustments are made, the controller 42 retests the dryness of the ink to see if the ink is dry and, if not, readjusts the settings again until a desired dryness of the ink is achieved. Thereafter, the printing surface 18 may be removed from the printing press 10 and used.

In yet another embodiment, a method of drying ink established on the printing surface 18 includes both predicting at least one drying parameter for the printing press 10 (according to embodiment(s) described above, e.g. in conjunction with FIG. 2); and verifying/determining that the ink established on the printing surface 18 is dry (according to embodiment(s) described above, e.g. in conjunction with FIG. 3).

It is to be understood that the term “connect/connected” is broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connected to” the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A method of predicting at least one drying parameter for a printing press, the printing press configured to deposit an ink on a printing surface to form an image, the method comprising:
estimating an amount and a type of the ink to be deposited on the printing surface;
determining at least one of: i) a type of the printing surface, ii) a thickness of the printing surface, and iii) a speed of the printing surface moving through the printing press; and
calculating, via a controller associated with the dryer, the at least one drying parameter based at least on: i) the amount and the type of the ink to be deposited on the printing surface; ii) the type of the printing surface, iii) the thickness of the printing surface, and iv) the speed of the printing surface moving through the printing press.

2. The method as defined in claim 1 wherein the calculating of the at least one drying parameter comprises:
determining i) an estimated average ink coverage amount, ii) an estimated highest ink coverage amount, and iii) an expected variation of the ink coverage amount;
inputting, into the controller, at least i) the estimated average ink coverage amount, ii) the estimated highest ink coverage amount, and iii) the expected variation of the ink coverage amount; and
utilizing the controller to determine the at least one drying parameter, sufficient to dry the ink to be deposited on the printing surface.

3. The method as defined in claim 2 wherein the at least one drying parameter is sufficient to dry the ink to be deposited on the printing surface without excessive drying.

4. The method as defined in claim 1 wherein the estimating of the type of the printing surface is accomplished by manually inputting the type into the computer program.

5. The method as defined in claim 1 wherein the estimating of the type of the printing surface is accomplished by:
scanning a barcode label associated with the printing surface using a barcode scanner; and
automatically inputting, into the controller, the type of printing surface scanned by the barcode scanner.

6. The method as defined in claim 1 wherein the at least one drying parameter includes a dryer air temperature, a dryer air velocity, a dryer air flow rate, a humidity level inside the dryer, a printing surface dwell time inside the dryer, an energy level of the dryer, a frequency level of the dryer, or combinations thereof.

7. The method as defined in claim 1, further comprising inputting, into the mathematical model, a performance history of the dryer.

8. The method as defined in claim 1, further comprising confirming the at least one drying parameter by measuring at least one of: a temperature of the printing surface having a dried image established thereon; a moisture content of the printing surface having the dried image established thereon; a flow rate of at least one element of the ink present in an exhaust stream operatively associated with the dryer; roller tracking of the printing press; blocking of the printing press; smearing of the printing press; or web tracking of the printing press.

9. A method of determining if an ink established on a printing surface is dry, the method comprising:
measuring at least one element present in an exhaust stream of a dryer associated with a printing press used to establish the ink on the printing surface;
determining the at least one element present in the ink established on the printing surface; and
comparing the at least one element present in the exhaust stream with one of i) the at least one element present in the ink prior to drying the ink, ii) the at least one element present in the ink after drying the ink, or iii) a predetermined value of the at least one element.

10. The method as defined in claim 9 wherein the at least one element includes at least one volatile organic compound (VOC), an aldehyde, water, temperature, or combinations thereof.

11. The method as defined in claim 9 wherein the measuring of the at least one element present in the exhaust stream includes:
identifying the at least one element; and
determining a flow rate, a moisture content, or a temperature of the identified at least one element.

12. The method as defined in claim 11 wherein the identifying and the determining are accomplished using at least one sensor operatively connected to the exhaust stream.

13. The method as defined in claim 12 wherein the at least one sensor includes a first sensor angularly offset about ninety degrees from a second sensor, and wherein the first and second sensors are placed in the exhaust stream in a location where laminar flow of the at least one element occurs.

14. The method as defined in claim 9 wherein the measuring of the at least one element in the exhaust stream is accomplished by:
collecting the at least one element from the exhaust stream; and
determining, from the collection, the at least one element via gas chromatography, mass spectroscopy, dinitro-phenyl hydraxine air sampling, photo-ionization detection, or combinations thereof.

15. The method as defined in claim 9 wherein if the ink established on the printing sample is determined not to be dry, the method further comprises:
determining a level of dryness of the ink based on at least one printing degradation factor; and
correlating the at least one element present in the exhaust stream with the level of dryness.

16. The method as defined in claim 15, further comprising adjusting, via a controller operatively associated with at least one of the dryer or the printing press, at least one of i) a parameter of the dryer or ii) a parameter of the printing press to achieve a target dryness level of the ink established on the printing surface based on the correlation between the at least one element present in the exhaust stream and the level of dryness.

17. The method as defined in claim 16 wherein the parameter of the printing press includes a type of the printing surface, a thickness of the printing surface, a speed of the printing surface, a moisture content of the printing surface, an amount of ink established on the printing surface, a composition of the ink, an amount of bonding agent used in combination with the ink, or combinations thereof; and

18. The method as defined in claim 16 wherein the parameter of the dryer includes an air temperature of the dryer, an air velocity of the dryer impinging on the printing surface, a humidity level of the dryer, an exposure time of the printing surface to the air in the dryer, a moisture content of make up air, a temperature of make up air, or combinations thereof.

19. A printing press, comprising:
a printhead configured to establish an ink on a printing surface, the ink including at least one element.
a dryer operatively configured to dry the ink established on the printing surface, the dryer in fluid communication with an exhaust stream for exhausting the at least one element;
at least one sensor operatively connected to the exhaust stream of the dryer, the at least one sensor configured to at least one of i) determine a flow rate of the at least one element present in the exhaust stream, ii) determine a moisture content of the exhaust stream, iii) determine a temperature of the exhaust stream, or iv) identify the at least one element; and
a controller in operative communication with the at least one sensor and the dryer, wherein the controller includes at least one program for determining a level of dryness of the ink established on the printing surface based on a comparison of the at least one element of the exhaust stream and one of i) the at least one element present in the ink established on the printing surface prior to drying the ink, ii) the at least one element present in the ink established on the printing surface after drying the ink, or iii) a predetermined value for the at least one element.

20. The printing press as defined in claim 19 wherein the dryer is configured for at least one of automatic or manual adjustment.
